(19) United States
(12) Patent Application Publication
(10) Pub. No.: US 2012/0154274 A1
(43) Pub. Date: Jun. 21, 2012

(54) INPUT DEVICE AND INFORMATION PROCESSING APPARATUS

(75) Inventors: Akira IWAMOTO, Osaka (JP); Masaru FURUJIKU, Osaka (JP); Yoshinari MATSUYAMA, Osaka (JP)

(73) Assignee: PANASONIC CORPORATION, Osaka (JP)

(21) Appl. No.: 13/331,701

(22) Filed: Dec. 20, 2011

(30) Foreign Application Priority Data
Dec. 21, 2010 (JP) 2010-284882

(51) Int. Cl. G06F 3/033; G06F 3/02; G06F 3/041

(52) U.S. Cl. 345/157; 345/173

(57) ABSTRACT

An input device with improved operability is provided. A first button and a second button are provided so as to extend to an area between a keyboard and a pad portion. With this configuration, when a user operates the first button and the second button while placing his/her both hands on the home positions of the keyboard, only a small amount of movement of fingers (for example, first fingers) is required, and therefore the user can operate the first button and the second button without significantly moving his/her both hands from the home positions. In other words, the user can operate the first button and the second button without stopping an input operation with the keyboard.

### BACKGROUND OF THE INVENTION

1. Field of the Invention

The present invention relates to an input device and an information processing apparatus including the same.

2. Description of Related Art

In recent years, information processing apparatuses such as notebook type personal computers (hereinafter referred to as “notebook computers”) have been designed in various ways to allow users to operate input devices such as a keyboard and a pointing device with comfort.

JP 2003-308166A discloses a pad type pointing device equipped with a first button that is provided between a keyboard and a pad surface and a second button that is provided in front of the pad surface. The first button is a button that is responsive to the operation of a pointing stick provided in the keyboard. The second button is a button that is responsive to the operation of the pad surface.

In the configuration disclosed in Patent Document 1, however, different functions are assigned to the first button and the second button. Accordingly, in the case of performing an input operation by using the keyboard and the second button, the user has to move his/her hands or fingers that are on their home positions of the keyboard to the second button side in order to operate the second button. Since the keyboard and the second button are positioned away from each other, the user has to move his/her both hands or fingers from the home positions each time he/she operates the second button, reducing the operability.

### SUMMARY OF THE INVENTION

An input device disclosed in the present invention includes: a pad portion that accepts a touch operation by a user; a plurality of buttons that are provided at least partially around the pad portion and each have a plurality of displacement portions capable of being displaced by a press operation by the user; and a switch that is provided under each of the displacement portions of the buttons, wherein a displacement portion corresponding to a pressed point of the button pressed by the user is displaced, and thereby a conductive state of the switch located under the displacement portion is switched.

An information processing apparatus disclosed in the present invention is an information processing apparatus including: a keyboard including a plurality of keys; and a pointing device disposed close to the keyboard, the pointing device including: a pad portion that accepts a touch operation by a user; a plurality of buttons that are provided at least partially around the pad portion and each have a plurality of displacement portions capable of being displaced by a press operation by the user; and a switch that is provided under each of the displacement portions of the buttons, wherein a displacement portion corresponding to a pressed point of the button pressed by the user is displaced, and thereby a conductive state of the switch located under the displacement portion is switched, and at least one of the plurality of switches provided under each of the buttons is disposed close to the keyboard.

According to the disclosure of the present invention, the user can operate the pad surface and the buttons associated with the pad surface without significantly moving his/her both hands or fingers from the home positions of the keyboard, and therefore improved operability can be attained.

### BRIEF DESCRIPTION OF THE DRAWINGS

FIG. 1 is a perspective view of a notebook computer.

FIG. 2 is a plan view of a first housing.

FIG. 3 is an enlarged plan view of a pointing device

FIG. 4A is a cross-sectional view taken along the line Z-Z of FIG. 3.

FIG. 4B is a cross-sectional view showing a state in which a third displacement portion has been pressed.

FIG. 4C is a cross-sectional view showing a state in which a fourth displacement portion has been pressed.

FIG. 5 is a plan view showing a state in which a keyboard and a pointing device are being operated by a user.

FIG. 6 is a plan view of an input device according to Variation 1.

FIG. 7 is a plan view of an input device according to Variation 2.

FIG. 8A is a cross-sectional view taken along the line Z-Z of FIG. 7.

FIG. 8B is a cross-sectional view showing a state in which a third displacement portion has been pressed.

FIG. 8C is a cross-sectional view showing a state in which a fourth displacement portion has been pressed.

FIG. 9 is a plan view of an input device according to Variation 3.

### DETAILED DESCRIPTION OF THE INVENTION

### Embodiment

### 1. Configurations of Information Processing Apparatus and Input Device

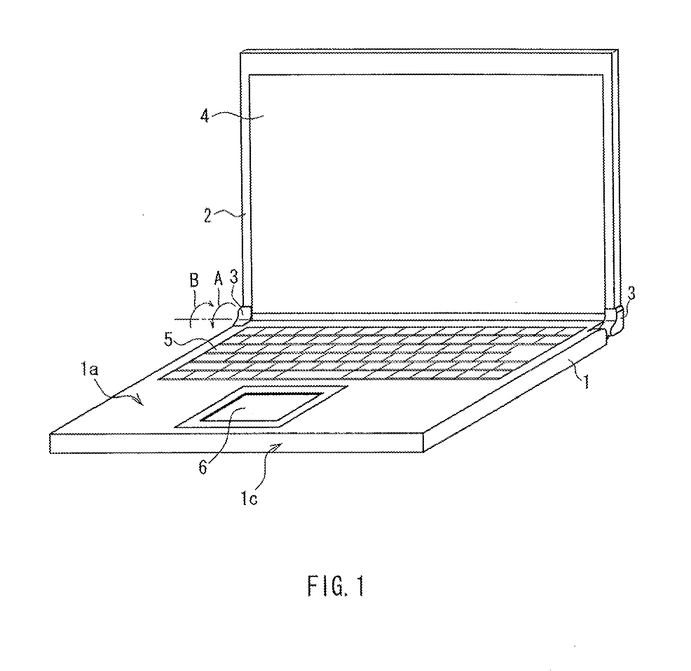

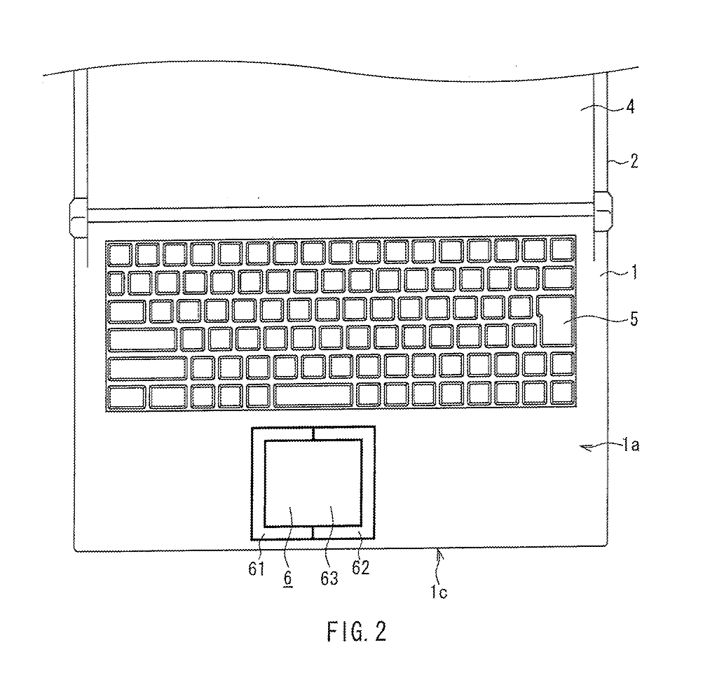

FIG. 1 is a perspective view showing the external configuration of a notebook computer according to the present embodiment. FIG. 2 is a plan view of a top surface 1a of a first housing 1.

As shown in FIG. 1, the notebook computer includes the first housing 1 and a second housing 2. The first housing 1 is provided internally with a circuit board on which various types of electrical elements are mounted, a hard disk drive and the like. The second housing 2 is provided with a display panel 4. The display panel 4 can be implemented as, for example, a liquid crystal display panel.

The first housing 1 and the second housing 2 are supported by a hinge portion 3 such that these housings can swing relative to each other. The hinge portion 3 includes a swing shaft that supports the first housing 1 and the second housing 2 such that the housings can swing in the direction indicated by the arrow A or B. As shown in FIG. 2, a keyboard 5 and a pointing device 6 are provided on the top surface 1a of the first housing 1. The keyboard 5 is disposed closer to the swing shaft on the top surface 1a of the first housing 1. The pointing device 6 is disposed between the keyboard 5 and a boundary between the top surface 1a of the first housing and a front surface 1c. The front surface is of the first housing is a surface that is adjacent to the top surface 1a and that faces a user when he/she operates the notebook computer. In other words, the pointing device 6 is disposed closer to the user operating the notebook computer than the keyboard 5 is. The present embodiment uses a notebook computer as an example of the information processing apparatus, but any apparatus that is provided with at least a pointing device can be used.

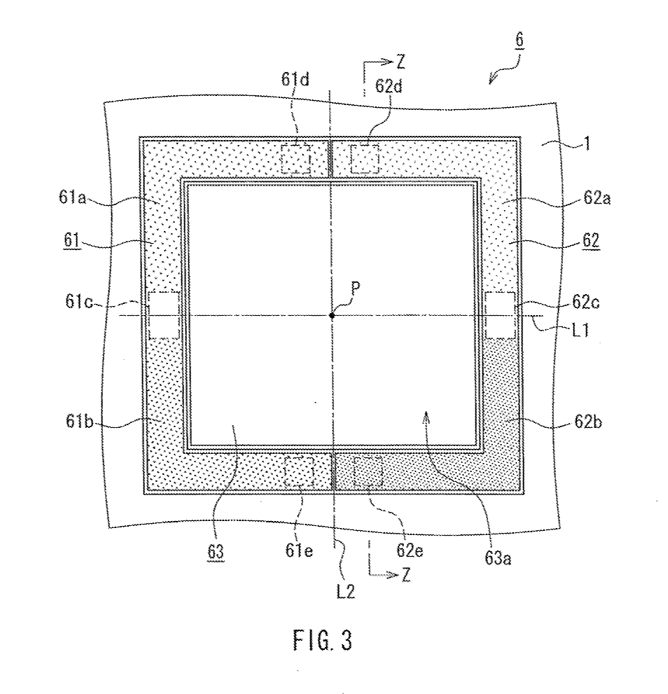

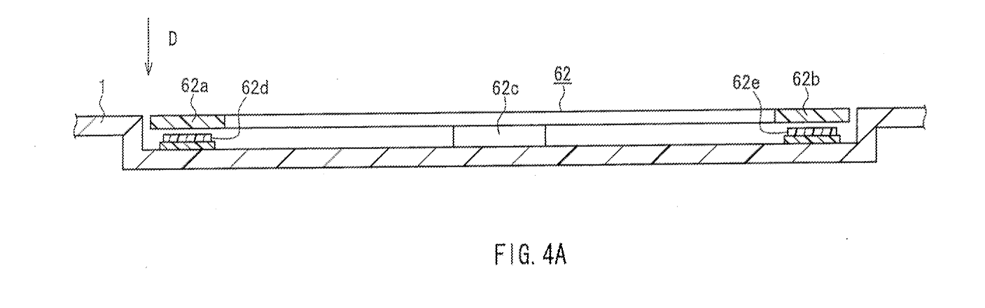

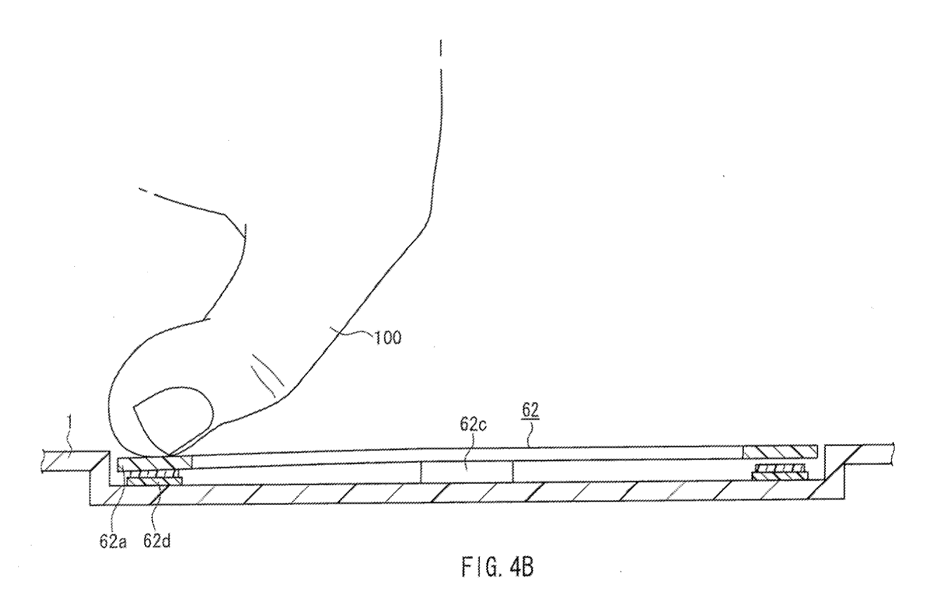

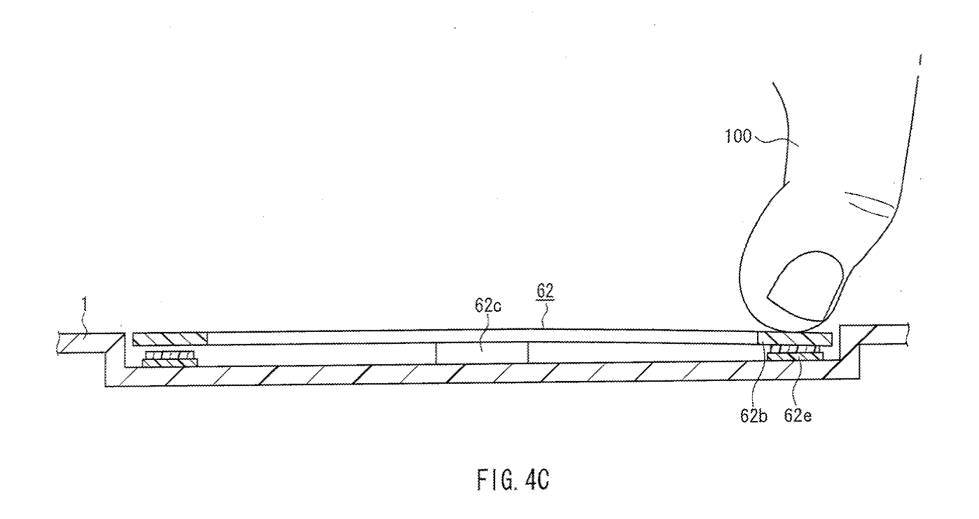

FIG. 3 is an enlarged plan view of the pointing device 6. FIGS. 4A to 4C are cross-sectional views taken along the line Z-Z of FIG. 3. FIG. 4A shows a state in which a second button 62 has not been pressed by the user. FIGS. 4B and 4C show states in which the second button 62 has been pressed by a user finger 100. FIGS. 4A to 4C show cross-sectional views of a portion where the second button 62 is prese, but a first button 61 also has the same configuration. Also, normally FIGS. 4A to 4C should show a cross-sectional shape of a pad portion 63, but for the sake of clarity of the configuration of the second button 62, illustration of the pad portion 63 is omitted.

The pointing device 6 includes the first button 61, the second button 62, and the pad portion 63.

As shown in FIG. 3, the first button 61 has a planar shape formed in an approximately rectangular U-shape. The first button 61 is fixed to a first fixing portion 61c. The first fixing portion 61c is formed integrally with the first housing 1. The first fixing portion 61c is disposed on a line segment L1 passing through a center P of the pad portion 63. The line segment L1 is an imaginary line bisecting the pad portion 63 into the keyboard 5 side and the front surface 1c side. In other words, the first button 61 is fixed to the first fixing portion 61c, at the center in the lengthwise direction of the first button 61. The first button 61 is made of a resiliently deformable material and has a resiliently deformable shape so that portions (a first displacement portion 61a and a second displacement portion 61b, which will be described below) other than the portion fixed to the first fixing portion 61c can be resiliently deformed. In the present embodiment, the first button 61 is made of a resin material having a thickness of approximately 5 mm in order to make it resiliently deformable, but the thickness and the material can be changed as appropriate. The first button 61 includes the first displacement portion 61a and the second displacement portion 61b in positions other than the position fixed to the first fixing portion 61c. The first displacement portion 61a is in a floating position (is spaced apart) from the first housing 1 and a first switch 61d, when in a state in which it is not pressed by the user and thus not displaced. The second displacement portion 61b is in a floating position (is spaced apart) from the first housing 1 and a second switch 61e, when in a state in which it is not pressed by the user and thus not displaced. The first displacement portion 61a is not necessarily in a floating position from the first switch 61d, and may be in contact with the first switch 61d when in the state in which it is not pressed by the user, as long as it does not cause the first switch 61d to become conductive. Likewise, the second displacement portion 61b is not necessarily in a floating position from the second switch 61e, and may be in contact with the second switch 61e when in the state in which it is not pressed by the user, as long as it does not cause the second switch 61e to become conductive. The first displacement portion 61a and the second displacement portion 61b are capable of being displaced independently of each other, and therefore may be capable of being displaced simultaneously.

As shown in FIG. 3, the second button 62 has a planar shape formed in an approximately rectangular U-shape. The second button 62 is fixed to a second fixing portion 62c. The second fixing portion 62c is formed integrally with the first housing 1. The second fixing portion 62c is disposed on the line segment L1 passing through the center P of the pad portion 63. In other words, the second button 62 is fixed to the second fixing portion 62c, at the center in the lengthwise direction of the second button 62. The second button 62 is made of a resiliently deformable material and has a resiliently deformable shape so that portions (a third displacement portion 62a and a fourth displacement portion 62b, which will be described below) other than the portion fixed to the second fixing portion 62c can be resiliently deformed. In the present embodiment, the second button 62 is made of a resin material having a thickness of approximately 5 mm in order to make it resiliently deformable, but the thickness and the material can be changed as appropriate. The second button 62 includes the third displacement portion 62a and the fourth displacement portion 62b in positions other than the position fixed to the second fixing portion 62c. As shown in FIG. 4A, the third displacement portion 62a is in a floating position (is spaced apart) from the first housing 1 and a third switch 62d when in a state in which it is not pressed by the user and thus not displaced. As shown in FIG. 4A, the fourth displacement portion 62b is in a floating position (is spaced apart) from the first housing 1 and a fourth switch 62e when in a state in which it is not pressed by the user and thus not displaced. The third displacement portion 62a is not necessarily in a floating position from the third switch 62d, and may be in contact with the third switch 62d when in the state in which it is not pressed by the user, as long as it does not cause the third switch 62d to become conductive. Likewise, the fourth displacement portion 62b is not necessarily in a floating position from the fourth switch 62e, and may be in contact with the fourth switch 62e when in the state in which it is not pressed by the user, as long as it does not cause the fourth switch 62e to become conductive. The third displacement portion 62a and the fourth displacement portion 62b are capable of being displaced independently of each other, and therefore may be capable of being displaced simultaneously.

It is preferable that parts that are made of the same material and have the same shape are used for the first button 61 and the second button 62, and the first button 61 and the second button 62 are disposed symmetrically about a line segment L2 shown in FIG. 3 when they are attached to the first housing 1, because the button production can be simplified. Here, the line segment L2 is an imaginary line that passes through the center P of the pad portion 63 and is orthogonal to the line segment L1.

The first switch 61d is disposed under the first displacement portion 61a, which is located on the keyboard 5 side, of the first button 61 (specifically, in a portion that is immediately below the keyboard 5 side of the first displacement portion 61a). The second switch 61e is disposed under the second displacement portion 61b, which is located on the front surface 1c side, of the first button 61 (specifically, in a portion that is immediately below the front surface 1c side of the second displacement portion 61b). The third switch 62d is disposed under the third displacement portion 62a, which is located on the keyboard 5 side, of the second button 62 (specifically, in a portion that is immediately below the keyboard 5 side of the third displacement portion 62a). The fourth switch 62e is disposed under the fourth displacement portion 62b, which is located on the front surface 1c side, of the second button 62 (specifically, in a portion that is immediately below the front surface 1c side of the fourth displacement portion 62b).

It is preferable that the first switch 61d and the second switch 61e are disposed in positions that are as remote as possible from the first fixing portion 61c. The reason is that the first displacement portion 61a and the second displacement portion 61b can be displaced more significantly at positions that are further away from the first fixing portion 61c, and the first displacement portion 61a and the second displacement portion 61b easily can be caused to abut the first switch 61d and the second switch 61e when they are pressed by the user and displaced. Also, it is preferable that the third switch 62d and the fourth switch 62e are disposed in positions that are as remote as possible from the second fixing portion 62c. The reason is that the third displacement portion 62a and the fourth displacement portion 62b can be displaced more significantly at positions that are further away from the second fixing portion 62c, and the third displacement portion 62a and the fourth displacement portion 62b easily can be caused to abut the third switch 62d and the fourth switch 62e when they are pressed by the user and displaced.

The first displacement portion 61a and the third displacement portion 62a are disposed in a position close to the keyboard 5. The first switch 61d and the third switch 62d are also disposed in the position close to the keyboard 5. As used herein, “the position close to the keyboard 5” refers to a position in which, when the user puts the second fingers of his/her both hands on the home positions (the F and J keys) of the keyboard 5, the first fingers are placed or in which the first fingers can be placed on the first button 61 and the second button 62 by slightly moving the first fingers. The expression “to slightly move the first fingers” means the amount of movement of the first fingers by which the user can place the first fingers on the first button 61 and the second button 62 without moving the second fingers from the home positions (the F and J keys) of the keyboard 5. It is preferable that when the first fingers are placed on the first button 61 and the second button 62, the hands and arms are in a natural posture (the posture that does not cause intense fatigue to the user). Also, the position close to the keyboard 5 can be a position, for example, approximately 10 to 30 mm apart from the C, V, B, N and M keys and the like in a direction orthogonal to the layout direction of these keys in the case of, for example, a QWERTY layout keyboard.

In the present embodiment, the same function is assigned to the first switch 61d and the second switch 61e, the same function is assigned to the third witch 62d and the fourth switch 62e, and different functions are assigned to the first switch 61d and the third switch 62d. The functions assigned to the respective switches may be preset with an operating system and application software that have been installed on the notebook computer, or the user may assign any functions. For example, it is possible to assign a designation function to the first switch 61d and the second switch 61e and a cancellation function to the third switch 62d and the fourth switch 62e.

The pad portion 63 consists of a flat-shaped pressure sensor, capacitive sensor or the like. The sensor of the pad portion 63 detects a change in pressure or capacitance when a user finger or the like touches a pad surface 63a, and transmits a detected signal to a signal processing unit (not shown) of the notebook computer. The signal processing unit (not shown) senses, for example, the position, in the pad surface 63a, touched by the finger or the like and the movement of the finger based on the detected signal transmitted from the sensor, and controls, for example, a pointer displayed on the display panel 4 to move to the designated position.

Hereinafter, the operations of the buttons of the pointing device 6 will be described.

The first button 61 is spaced apart from the first switch 61d and the second switch 61e when not pressed by the user. Likewise, the second button 62 is spaced apart from the third switch 62d and the fourth switch 626 when not pressed by the user as shown in, for example, FIG. 4A.

As shown in FIG. 4B, if a user finger 100 presses the third displacement portion 62a of the second button 62 in the direction indicated by the arrow D (see FIG. 4A), the third displacement portion 62a is displaced. Specifically, because the second button 62 is fixed to the second fixing portion 62c, the third displacement portion 62a is curved and deformed when it is pressed in the direction indicated by the arrow D. When the third displacement portion 62a is displaced to a predetermined position and caused to abut the third switch 62d, a contact point (not shown) of the third switch 62d becomes conductive. At this time, the fourth displacement portion 62b is not displaced because the second button 62 is fixed to the second fixing portion 62c.

Also, as shown in FIG. 4C, if the user finger 100 presses the fourth displacement portion 62b of the second button 62 in the direction indicated by the arrow D (see FIG. 4A), the fourth displacement portion 62b is displaced. Specifically, because the second button 62 is fixed to the second fixing portion 62c, the fourth displacement portion 62b is curved and deformed when it is pressed in the direction indicated by the arrow D. When the fourth displacement portion 62b is displaced to a predetermined position and caused to abut the fourth switch 62e, a contact point (not shown) of the fourth switch 62e becomes conductive. At this time, the third displacement portion 62a is not displaced because the second button 62 is fixed to the second fixing portion 62c.

In the foregoing, the operation of the second button 62 when it is pressed by the user finger 100 has been described. The operation of the first button 61 when it is pressed by the user is the same as the operation of the second button 62 because the first button 61 has the same configuration as the second button 62.

### 2. Method for Operating Information Processing Apparatus

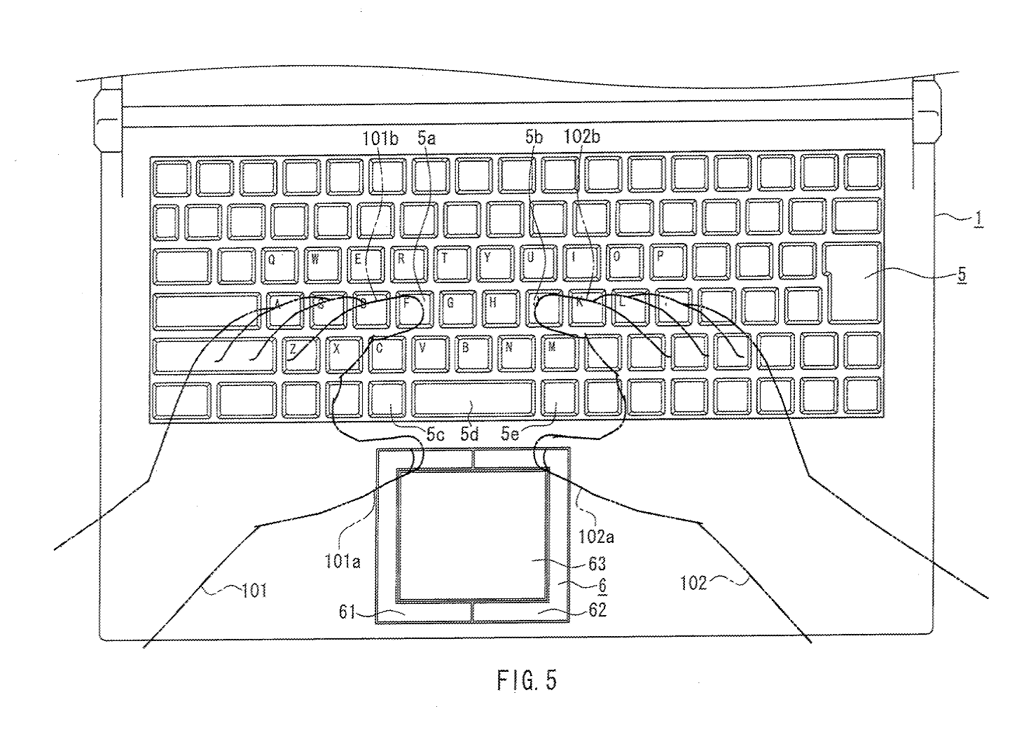

FIG. 5 is a plan view showing a state in which the user is operating the keyboard 5. In order to clearly illustrate the configuration of the keyboard 5 and the pointing device 6, only the first housing 1 is illustrated in FIG. 5.

In FIG. 5, user's left hand 101 and right hand 102 are placed on the home positions of the keyboard 5. The “home positions” refers to an F key 5a and a J key 5b of the keyboard 5. The expression “placed on the home positions” refers to the state in which a second finger 101b (index finger) of the user left hand 101 is placed on the F key 5a of the keyboard 5 and a second finger 102b (index finger) of the right hand 102 is placed on the J key 5b of the keyboard 5. The user operates the keyboard 5 while placing his/her both hands on the home positions of the keyboard 5, and thus the amount of movement of each finger of the hands can be reduced and the user can perform typing efficiently. FIG. 5 illustrates an example in which a first finger 101a (thumb) of the left hand 101 is placed on the first button 61 and a first finger 102a (thumb) of the right hand 102 is placed on the second button 62, but when the user is operating only the keyboard 5 without operating the pointing device 6, the first finger 101a of the left hand 101 and the first finger 102a of the right hand 102 are usually placed on the keyboard 5 (for example, any of keys 5c to 5e).

In the case where the user operates the pointing device 6 while placing the left hand 101 and the right hand 102 on the home positions of the keyboard 5, the first finger 101a of the left hand 101 and the first finger 102a of the right hand 102 are used.

Specifically, in the case where the user operates the pad portion 63 of the pointing device 6 while placing the left hand 101 and the right hand 102 on the home positions of the keyboard 5, the first finger 101a of the left hand 101 or the first finger 102a of the right hand 102 is moved from the keyboard 5 (for example, any of the keys 5c to 5e) to the pad portion 63. At this time, although it depends on the size of the user's user hands and the length of the user's fingers, the first finger 101a or 102a can be moved to the pad portion 63 while the second finger 101b of the left hand 101 or the second finger 102b of the right hand 102 is still placed on the home position of the keyboard 5. In this case, the amount of movement of the hand is small, and it is therefore possible to switch rapidly between an input operation using the keyboard 5 and an input operation using the pad portion 63. The user can perform an input operation using the pad portion 63 by touching the pad surface 63a with a finger that has been moved to the pad portion 63.

In the case where the user operates the first button 61 of the pointing device 6 while placing the left hand 101 and the right hand 102 on the home positions of the keyboard 5, the first finger 101a of the left hand 101 is moved from the keyboard 5 (for example, any of the keys 5c to 5e) to the first displacement portion 61a of the first button 61. At this time, although it depends on the size of the user's hands and the length of the user's fingers, the first finger 101a can be moved to the first displacement portion 61a of the first button 61 while the second finger 101b of the left hand 101 is still placed on the home position (the F key 5a) of the keyboard 5. At least a portion of the first button 61 that overlaps the first switch 61d is located at a position closer to the keyboard 5 than the pad portion 63 is, and therefore the amount of movement of the first finger 101a of the left hand 101 is smaller than the amount of movement of the first finger 101a when operating the pad portion 63. Accordingly, it is highly likely that the first finger 101a can be moved to the first displacement portion 61a of the first button 61 while the second finger 101b of the left hand 101 is still placed on the home position (the F key 5a) of the keyboard 5. By the user pressing the first displacement portion 61a (in the direction indicated by the arrow D in FIG. 4A) with his/her finger that has been moved to the first displacement portion 61a of the first button 61, it is possible to make the first switch 61d conductive and execute the function assigned to the first switch 61d.

In the case where the user operates the second button 62 of the pointing device 6 while placing the left hand 101 and the right hand 102 on the home positions of the keyboard 5, the first finger 102a of the right hand 102 is moved from the keyboard 5 (for example, any of the keys 5c to 5e) to the third displacement portion 62a of the second button 62. At this time, although it depends on the size of the user hands and the length of the user fingers, the first finger 102a can be moved to the third displacement portion 62a of the second button 62 while the second finger 102b of the right hand 102 is still placed on the home position (the J key 5b) of the keyboard 5. At least a portion of the second button 62 that overlaps the third switch 62d is located at a position closer to the keyboard 5 than the pad portion 63 is, and therefore the amount of movement of the first finger 102a of the right hand 102 is smaller than the amount of movement of the first finger 102a when operating the pad portion 63. Accordingly, it is highly likely that the first finger 102a can be moved to the third displacement portion 62a of the second button 62 while the second finger 102b of the right hand 102 is still placed on the home position (the J key 5b) of the keyboard 5. By the user pressing the third displacement portion 62a (in the direction indicated by the arrow D in FIG. 4A) with his/her finger that has been moved to the third displacement portion 62a of the second button 62, it is possible to make the third switch 62d conductive and execute the function assigned to the third switch 62d.

In the present embodiment, because the same function has been assigned to the first switch 61d and the second switch 61e, the same function is executed irrespective of whether the user has pressed the first displacement portion 61a or the second displacement portion 61b of the first button 61. Also, in the present embodiment, because the same function has been assigned to the third switch 62d and the fourth switch 62e, the same function is executed irrespective of whether the user has pressed the third displacement portion 62a or the fourth displacement portion 62b of the second button 62. Accordingly, in the case where the user performs an input operation by using only the pointing device 6 and not using the keyboard 5, by operating the pad portion 63 with the second finger 102b of the right hand 102, the second displacement portion 61b of the first button 61 with the first finger 101a of the left hand 101, and the fourth displacement portion 62b of the second button 62 with the first finger 102a of the right hand 102, he/she can perform an input operation using the pointing device 6 while both of his/her hands are in a natural posture.

### 3. Effects of the Embodiment, Etc.

The information processing apparatus according to the present embodiment is provided with, in addition to the second switch 61e and the fourth switch 62e, which are often incorporated in conventional notebook computers, the first switch 61d and the third switch 62d that are located at a position closer to the keyboard 5, and also provided with the first displacement portion 61a that is located in the first button 61 and capable of switching the first switch 61d into a conductive state and the third displacement portion 62a that is located in the second button 62 and capable of switching the third switch 62d into a conductive state. With this configuration, in the case where the user operates the first button 61 and the second button 62 while operating the keyboard 5 with both of his/her hands placed on the home positions of the keyboard 5, only a small amount of movement of fingers (for example, the first fingers 101a and 102a) is required, and therefore he/she can operate the first button 61 and the second button 62 without significantly moving his/her hands from the home positions. That is, the user can operate the first button 61 and the second button 62 without stopping an input operation with the keyboard 5.

Also, in the present embodiment, the same function has been assigned to the first switch 61d and the second switch 61e, and therefore it is possible to selectively use the first displacement portion 61a and the second displacement portion 61b of the first button 61 as necessary. Also, the same function has been assigned to the third switch 62d and the fourth switch 62e, and therefore it is possible to selectively use the third displacement portion 62a and the fourth displacement portion 62b of the second button 62 as necessary. For example, in the case where the user performs an input operation using both the keyboard 5 and the pointing device 6, the amount of movement of fingers will be small when the first displacement portion 61a of the first button 61 and the third displacement portion 62a of the second button 62 are used, and accordingly, the user can perform a button operation without the operability of the input operation using the keyboard 5 being compromised, and the sense of fatigue in his/her both hands can be reduced. Also, in the case where the user performs an input operation by using only the pointing device 6, the user can perform the input operation with both of his/her hands in a natural posture when the second displacement portion 61b of the first button 61 and the fourth displacement portion 62b of the second button 62 are used, and therefore the sense of fatigue in his/her both hands can be reduced.

The present embodiment has been described using the information processing apparatus (notebook computer) as an example of the apparatus that is provided with a pointing device (input device), but is also applicable to, for example, an input apparatus that is externally connectable to a notebook computer and provided with only a pointing device, or an input apparatus that is externally connectable to a notebook computer and provided with a pointing device and a keyboard.

In the present embodiment, a configuration is also possible in which the same function is assigned to the first switch 61d and the third switch 62d, the same function is assigned to the second switch 61e and the fourth switch 62e, and different functions are assigned to the first switch 61d and the second switch 61e. It is also possible to assign different functions to all four of these four switches.

Also, in the present embodiment, a configuration including two buttons (the first button 61 and the second button 62) is used, but it is also possible to use a configuration in which buttons are independently provided for the first switch 61d, the second switch 61e, the third switch 62d and the fourth switch 62e in overlapping positions. In other words, four buttons corresponding to the four switches may be provided. In this case, the same function is assigned to the first switch 61d and the third switch 62d, and the same function is assigned to the second switch 61e and the fourth switch 62e.

Also, the first fixing portion 61c and the second fixing portion 62c of the present embodiment are each configured to have a shape through which the imaginary line L1 bisecting the pad portion 63 into the keyboard 5 side and the front surface 1c side passes, but the first fixing portion 61c and the second fixing portion 62c can be disposed as appropriate according to the separation distance from the keyboard 5 to the first button 61 and the second button 62.

Also, the pointing device 6 of the present embodiment is an example of the input device. The notebook computer of the present embodiment is an example of the information processing apparatus. The pad portion 63 of the present embodiment is an example of the pad portion. The first button 61 and the second button 62 of the present embodiment are examples of the plurality of buttons. The first button 61 of the present embodiment is an example of the first button. The second button 62 of the present embodiment is an example of the second button. The first switch 61d, the second switch 61e, the third switch 62d and the fourth switch 62e of the present embodiment are examples of the plurality of switches. The first switch 61d of the present embodiment is an example of the first switch. The second switch 61e of the present embodiment is an example of the second switch. The third switch 62d of the present embodiment is an example of the third switch. The fourth switch 62e of the present embodiment is an example of the fourth switch.

The following provides variations of the input device of the present embodiment.

### Variation 1

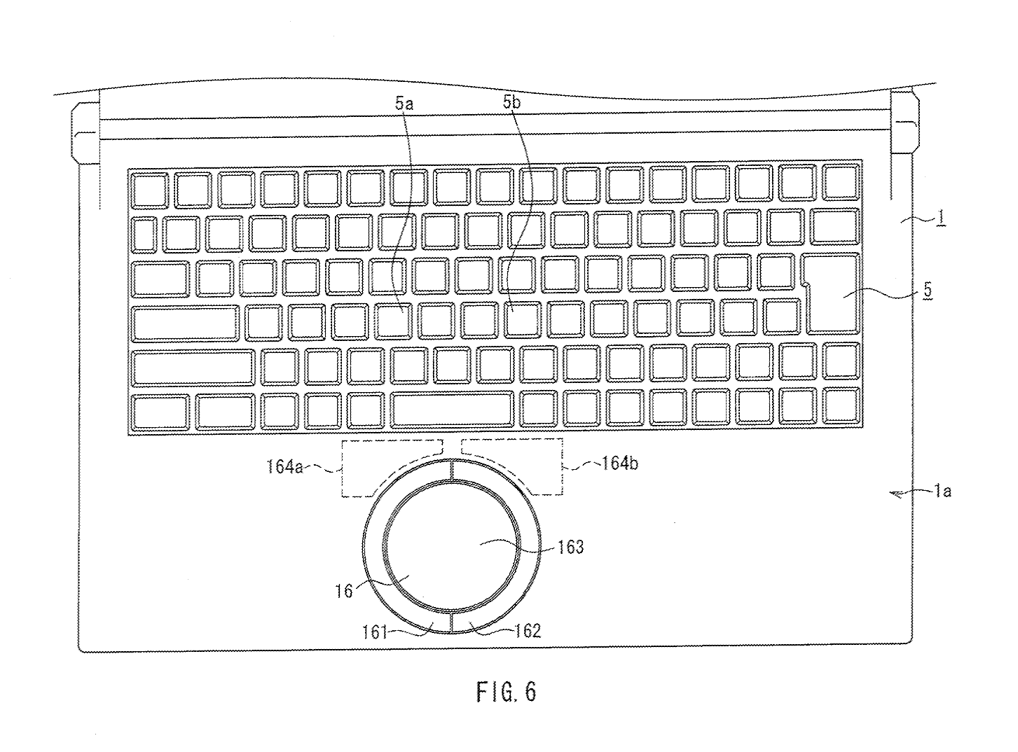

FIG. 6 is a plan view of a first housing 1 provided with a pointing device having another configuration. An information processing apparatus shown in FIG. 6 is provided with a pointing device 16 having a circular planar shape. The pointing device 16 includes a first button 161, a second button 162 and a pad portion 163. The respective configurations and functions of the first button 161, the second button 162 and the pad portion 163 are the same as those of the first button 61, the second button 62 and the pad portion 63 described in the embodiment above. The pad portion 163 has a circular planar shape. The first button 161 and the second button 162 are formed in an arc shape and disposed to surround the pad portion 163.

With this configuration, the distance from the keyboard 5 to the first button 161 and the second button 162 can be reduced. As a result, the amount of movement of fingers when operating the first button 161 and the second button 162 while operating the keyboard 5 can be reduced, the user can perform a button operation without the operability of the input operation using the keyboard 5 being compromised, and the sense of fatigue in his/her both hands can be reduced.

Also, a region 164a for placing the first finger of the left hand can be provided between the keyboard 5 and the first button 161, and therefore the operability of an input operation using the keyboard 5 can be improved. Likewise, a region 164b for placing the first finger of the right hand can be provided between the keyboard 5 and the second button 162, and therefore the operability of an input operation using the keyboard 5 can be improved. Specifically, by placing the first fingers in the regions 164a and 164b, when the user performs an input operation using the keyboard 5 with fingers other than the first fingers while placing both of his/her hands on the home positions of the keyboard 5, the user can perform the input operation using the keyboard 5 with both of his/her hands in the natural posture, as a result of which the sense of fatigue felt by the user can be reduced. Also, providing the region 164a prevents operation errors in which the first button 161 and the pad portion 163 are operated with the first finger of the left hand. Also, providing the region 164b prevents operation errors in which the second button 162 and the pad portion 163 are operated with the first finger of the right hand.

### Variation 2

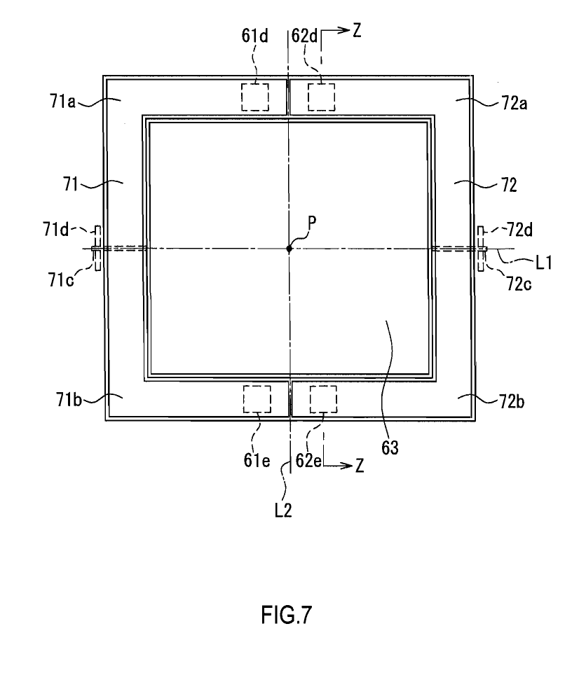

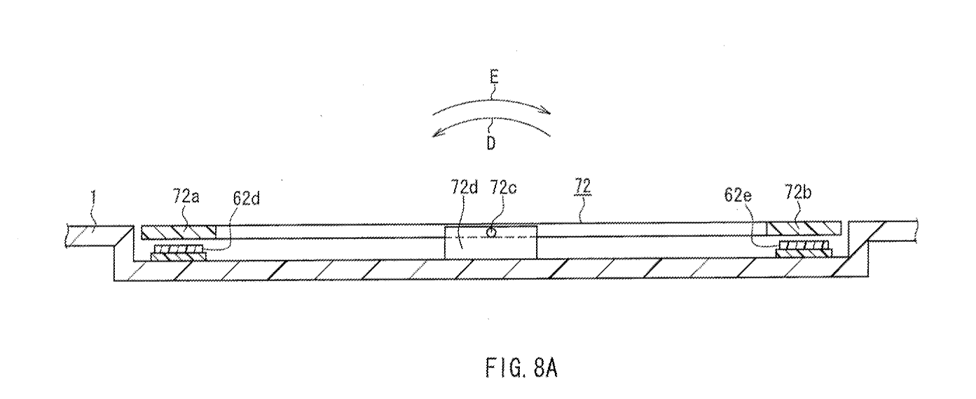

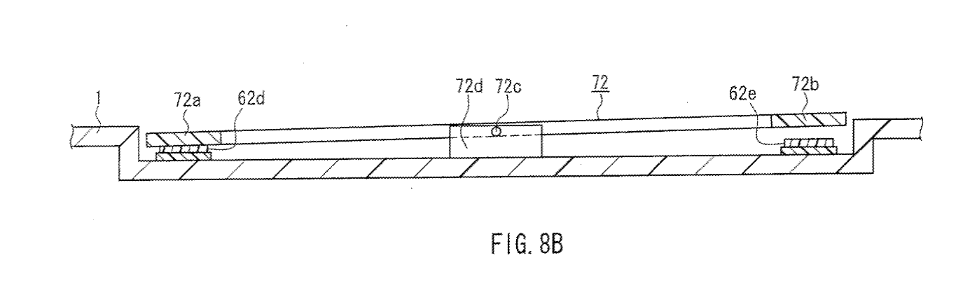

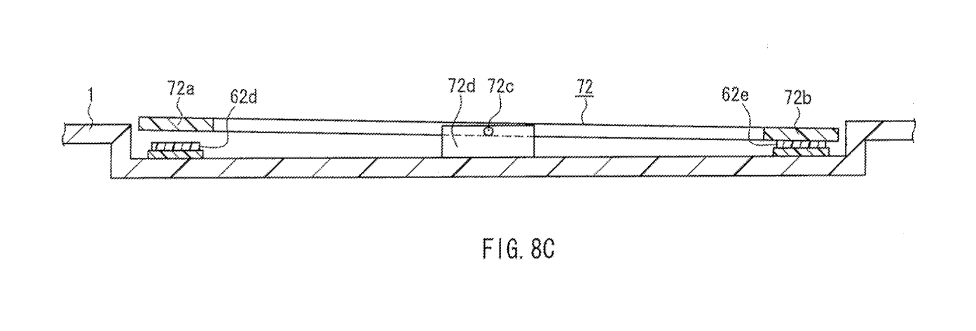

FIG. 7 is an enlarged plan view of a pointing device having another configuration. FIGS. 8A to 8C are cross sections taken along the line Z-Z of FIG. 7. In the pointing device shown in FIG. 7, constituent elements that are the same as those of the pointing device shown in FIG. 3 and the like have been given the same reference numerals, and detailed descriptions thereof are not given here. A feature of the pointing device shown in FIG. 7 lies in a button supporting structure with respect to the first housing 1.

A first button 71 includes a support shaft 71c. The support shaft 71c is rotatably supported in a hole of a supporting portion 71d formed in the first housing 1. Accordingly, the first button 71 is supported by the supporting portion 71d so as to be capable of rotation in the direction indicated by the arrow D or E (see FIG. 8A). Unlike the first button 61 shown in FIG. 3, the first button 71 preferably is made of a material that does not resiliently deform.

A second button 72 includes a support shaft 72c. The support shaft 72c is rotatably supported in a hole of a supporting portion 72d formed in the first housing 1. Accordingly, the second button 72 is supported by the supporting portion 72d so as to be capable of rotation in the direction indicated by the arrow D or E (see FIG. 8A). Unlike the second button 62 shown in FIG. 3, the second button 72 preferably is made of a material that does not resiliently deform.

The first button 71 is in a floating position (is spaced apart) from the first switch 61d and the second switch 61e when in a state in which it is not pressed by the user. Likewise, the second button 72 is in a floating position (is spaced apart) from the third switch 62d and the fourth switch 62e when in a state in which it is not pressed by the user as shown in FIG. 8A.

In the state shown in FIG. 8A, if the user presses a third displacement portion 72a of the second button 72 in the direction indicated by the arrow D, the second button 72 will be rotated in the direction indicated by the arrow D about the axis of the support shaft 72c. FIG. 8B shows a state in which the second button 72 has been rotated in the direction indicated by the arrow D and the second button 72 is in abutment with the third switch 62d. As shown in FIG. 8B, by bringing the third displacement portion 72a into abutment with the third switch 62d, a contact point (not shown) of the third switch 62d becomes conductive. At this time, a fourth displacement portion 72b of the second button 72 has been displaced to a position further away from the fourth switch 62e.

In the state shown in FIG. 8A, if the user presses the fourth displacement portion 72b of the second button 72 in the direction indicated by the arrow D, the second button 72 will be rotated in the direction indicated by the arrow E about the axis of the support shaft 72c. FIG. 8C shows a state in which the second button 72 has been rotated in the direction indicated by the arrow E and the second button 72 is in abutment with the fourth switch 62e. As shown in FIG. 8C, by bringing the fourth displacement portion 72b into abutment with the fourth switch 62e, a contact point (not shown) of the fourth switch 62e becomes conductive. At this time, the third displacement portion 72a of the second button 72 has been displaced to a position further away from the third switch 62d.

Although the illustration and description of a state in which the first button 71 is in abutment with the first switch 61d or the second switch 61e are not given here, the operations of the first button 71 when a first displacement portion 71a and a second displacement portion 71b are pressed/operated are approximately the same as the operations shown in FIGS. 8B and 8C.

According to the variation, the first button 71 and the second button 72 will suffer little degradation even if repeatedly pressed.

Variation 2 has been described in the context of the pad portion 63 having a rectangular shape, but it can be equally applied even to, for example, the pad portion 163 of Variation 1 having a circular shape. The effects obtained by using a circular shape are the same. At this time, the first button and the second button can have an arc shape as shown in Variation 1.

Variation 3

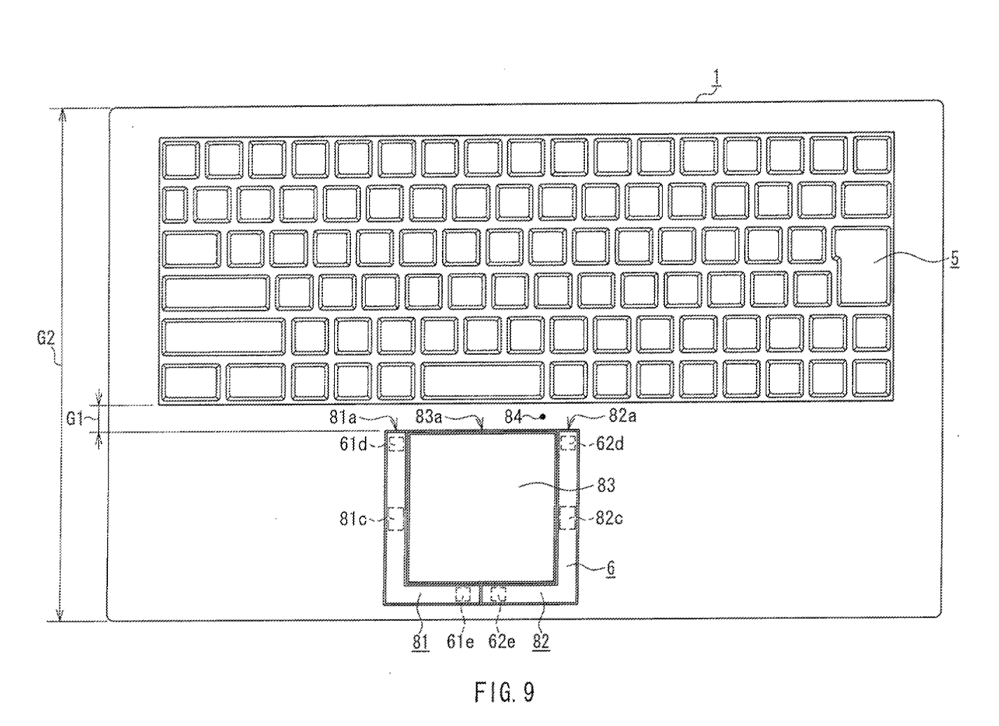

FIG. 9 is a plan view of a first housing provided with a pointing device having another configuration. In the pointing device shown in FIG. 9, constituent elements that are the same as those of the pointing device shown in FIG. 3 and the like have been given the same reference numerals, and detailed descriptions thereof are not given here. A feature of the pointing device shown in FIG. 9 lies in the shape of buttons.

A first button 81 is shaped such that an end portion 81a thereof is approximately flush with an end portion 83a (an end portion on the keyboard 5 side) of a pad portion 83. The first button 81 is fixed to a first fixing portion 81c. The first button 81 is formed to be resiliently deformable, as with the first button 61 shown in FIG. 3. The first switch 61d is disposed under the first button 81, at a position close to the end portion 81a.

A second button 82 is shaped such that an end portion 82a thereof is approximately flush with the end portion 83a (the end portion on the keyboard 5 side) of the pad portion 83. The second button 82 is fixed to a second fixing portion 82c. The second button 82 is formed to be resiliently deformable, as with the second button 62 shown in FIG. 3. The third switch 62d is disposed under the second button 82, at a position close to the end portion 82a.

The operations of the first button 81 and the second button 82 when pressed/operated by the user are the same as those shown in FIGS. 4A to 4C, and thus descriptions thereof are not given here.

With this configuration, a region 84 for placing the first fingers of the right and left hands can be provided between the keyboard 5 and the pointing device 6, and therefore the operability of an input operation using the keyboard 5 can be improved. Specifically, by placing the first fingers in the region 84, when the user performs an input operation using the keyboard 5 with fingers other than the first fingers while both of his/her hands are placed on the home positions of the keyboard 5, the user can perform the input operation using the keyboard 5 with both of his/her hands in a natural posture, as a result of which the sense of fatigue felt by the user can be reduced.

Also, a width G1 of the region 84 can be reduced, or in other words, the pointing device 6 can be disposed at a position closer to the keyboard 5, and a width G2 of the first housing 1 can be reduced accordingly, as a result of which the size of the first housing 1 can be reduced.

Variation 3 has been described in the context of the pad portion 83 having a rectangular shape, but it can be equally applied even to, for example, the pad portion 163 of Variation 1 having a circular shape. The effects obtained by using a circular shape are the same.

The present invention is useful for an input device and an information processing apparatus including the same.

### [Addendum]

The above embodiment and variations can be expressed in a different way as follows.

[1] An input device comprising:

a pad portion that accepts a touch operation by a user;

a plurality of buttons that are provided at least partially around the pad portion and capable of being displaced by a press operation by the user; and

a plurality of switches that are provided under each of the plurality of buttons,

wherein the plurality of switches include individual switches whose conductive states are switched depending on a pressed point of the button pressed by the user.

[2] The input device according to claim 1,

wherein the same function is assigned to the plurality of switches.

[3] The input device according to claim 1,

wherein the plurality of buttons include a first button and a second button,

a first switch and a second switch are provided under the first button, at positions opposed to each other across the pad portion,

a third switch and a fourth switch are provided under the second button, at positions opposed to each other across the pad portion,

the same function is assigned to the first switch and the second switch,

the same function is assigned to the third switch and the fourth switch, and

different functions are assigned to the first switch and the third switch.

[4] The input device according to any one of claims 1 to 3,

wherein the plurality of buttons are each independently resiliently deformable.

[5] The input device according to claim 1, further comprising a supporting portion that supports each of the plurality of buttons,

wherein each of the plurality of buttons is supported by the supporting portion so as to be capable of being deformed or rotated between a position that makes one of the plurality of switches conductive and a position that makes the other of the plurality of switches conductive.

[6] An information processing apparatus including:

a keyboard including a plurality of keys; and

a pointing device disposed close to the keyboard,

the pointing device comprising:
a pad portion that accepts a touch operation by a user;
a plurality of buttons that are provided at least partially around the pad portion and capable of being displaced by a press operation by the user, and
a plurality of switches that are provided under each of the plurality of buttons,
wherein the plurality of switches include individual switches whose conductive states are switched depending on a pressed point of the button pressed by the user, and
at least one of the plurality of switches is disposed close to the keyboard. What is claimed is:

1. An input device comprising;
a pad portion that accepts a touch operation by a user;
a plurality of buttons that are provided at least partially around the pad portion and each have a plurality of displacement portions capable of being displaced by a press operation by the user; and
a switch that is provided under each of the displacement portions of the buttons,
wherein a displacement portion corresponding to a pressed point of the button pressed by the user is displaced, and thereby a conductive state of the switch located under the displacement portion is switched.

2. The input device according to claim 1,
wherein the same function is assigned to the plurality of switches that are located under one of the buttons.

3. The input device according to claim 1,
wherein the plurality of buttons include a first button and a second button,
a first switch and a second switch are provided under the first button, at positions opposed to each other across the pad portion,
a third switch and a fourth switch are provided under the second button, at positions opposed to each other across the pad portion,
the same function is assigned to the first switch and the second switch,
the same function is assigned to the third switch and the fourth switch, and
different functions are assigned to the first switch and the third switch.

4. The input device according to claim 1,
wherein the plurality of displacement portions of the plurality of buttons are each independently resiliently deformable.

5. The input device according to claim 1, further comprising a supporting portion that supports each of the plurality of buttons,
wherein each of the plurality of buttons includes two displacement portions that are disposed on opposite sides of the supporting portion, and
the button is supported by the supporting portion so as to be capable of being deformed or rotated between a position that makes any one of the switches respectively disposed under the two displacement portions conductive and a position that makes the other switch conductive.

6. An information processing apparatus including:
a keyboard including a plurality of keys; and
a pointing device disposed close to the keyboard,
the pointing device comprising:
a pad portion that accepts a touch operation by a user;
a plurality of buttons that are provided at least partially around the pad portion and each have a plurality of displacement portions capable of being displaced by a press operation by the user; and
a switch that is provided under each of the displacement portions of the buttons,
wherein a displacement portion corresponding to a pressed point of the button pressed by the user is displaced, and thereby a conductive state of the switch located under the displacement portion is switched, and
at least one of the plurality of switches provided under each of the buttons is disposed close to the keyboard.
